(19) United States
(12) Patent Application Publication
(10) Pub. No.: US 2006/0209702 A1
(43) Pub. Date: Sep. 21, 2006

(54) Method for evaluating the bandwith of a digital link

(76) Inventors: Jean Schmitt, Rouvres (FR); Dominique Le Foll, Ivybridge Uve (FR); Bogdan Ghita, Bucharest (RO)

Correspondence Address: Robert E Krebs;Thelen Reid & Priest, P.O. Box 640640, San Jose, CA, 95164-0640, US

(21) Appl. No.: 10/549,988

(22) PCT Filed: Mar. 17, 2004
(86) PCT No.: PCT/FR04/50111

§ 371 Date: Sep. 19, 2005

(30) Foreign Application Priority Data
Mar. 19, 2003 (FR) 03/050056

(51) Int. Cl. H04J 1/16; H04L 12/56

(52) U.S. Cl. 370/252; 370/400

(57) ABSTRACT

The invention relates to a method for evaluating the bandwidth between a first point and a second point liable to exchange digital data packets in a telecommunications network including a plurality of sub-networks. The method according to the invention includes the following steps: for each transmission direction through at least one of said sub-networks, associating a same identifier with the quasi-simultaneously transmitted packets, time-stamping and recording the received packets, identifying and sorting the packets received with the same identifier, selecting the largest possible integral number m of groups of packets with the same identifier, measuring the time intervals separating the instants when the packets of the selected groups are received by the second point, calculating the bandwidth according to the number of packets of the selected groups and to said total transmission time of said packets.

### TECHNICAL FIELD

The invention pertains to the field of telecommunications and more specifically relates to a method for evaluating the bandwidth between a first and second point liable to exchange data packets via a digital link in a telecommunications network including a plurality of sub-networks.

The invention also relates to a device for applying the method.

The invention finds application in telecommunications networks such as the Internet network.

### STATE OF THE PRIOR ART

A known method for evaluating the bandwidth in a telecommunications network consists in transmitting from a first point of the network a file via FTP (File Transfer Protocol) including a time mark and in measuring the rate for receiving this file by a second point of said network. Transmission of a file with a large size via FTP in a link generates an overload of the network. Moreover, as the load generated by the users of the network at the instant of the measurement is unknown, a transfer of a file with a small size via FTP does not guarantee an optimum use of the available bandwidth. All these factors cause measurement of the file receiving rate and so, the available bandwidth upon transfer via FTP by the second point of the network, to be uncertain.

Another method known in the prior art, consists in measuring the absolute transmission time for a data file between both points of the network, time being measured at each point with the highest accuracy as possible. Of course, this method is more accurate but has a high cost insofar that it requires the use of a time measuring system with high accuracy at each end of the network, such as delivered by a GPS (Global Positioning System) type transmission system, for example.

The object of the invention is to overcome the drawbacks of the prior art as described above by means of a method and a simple low cost device capable of being used between any points of the network.

Another object of the invention is to isolate and unambiguously localize a congestion point when data exchanged between two points of a network transit through several sub-networks.

### DESCRIPTION OF THE INVENTION

The invention recommends a method for evaluating the bandwidth between a first point and a second point including terminals liable to exchange digital data packets in a telecommunications network including a plurality of sub-networks.

The method according to the invention includes the following steps:

for each transmission direction through at least one of said sub-networks,
a. associating a same identifier with the quasi-simultaneously transmitted packets,
b. time-stamping and recording the received packets,
c. identifying and sorting the packets received with the same identifier,
d. selecting the largest possible integral number m of groups of packets with the same identifier,
e. measuring the time intervals separating the instants when the packets of the selected groups are received by the second point,
f. calculating the bandwidth according to the number of packets of the selected groups and to the total transmission time of these packets.

By identifying the quasi-simultaneously transmitted packets in the flux transmitted from the first to the second point of the link, one is placed under the actual conditions of use of the network's users, under which estimation of the measured bandwidth reflects the actual congestion of the link at the instant of measurement.

In a preferred embodiment, the bandwidth is calculated with the following expression:

$$\overline{BW} = \frac{1}{m} {\sum }_{j = 1}^{m} [ \frac{1}{{n}_{m}} {\sum }_{i = 1}^{{n}_{m}^{- 1}} \frac{{l}_{i , m}}{{t}_{( i + 1 ) m} - {t}_{i , m}} ]$$

wherein
li,m represents the length of the packet of rank i of the m^{th} group of packets,
ti represents the time mark of the packet of rank i of the m^{th} group of packets,
ti+1 represents the time mark of the packet of rank i+1 of m^{th} group of packets,
n represents the number of packets of the m^{th} group of packets.

To improve the accuracy of the evaluation, the method is applied on a number of groups of packets larger than 1.

In a first embodiment of the invention, the evaluation of the bandwidth is performed on-line.

In a second embodiment of the invention, the evaluation of the bandwidth is performed off-line.

In a particular application of the invention the communications network is of the IP (Internet Protocol) type.

The invention also relates to a device for evaluating the bandwidth between a first point and a second point liable to exchange digital data packets in a telecommunications network including a plurality of sub-networks.

This device includes:
means for marking the transmitted packets,
means for time-stamping the received packets,
means for sorting the received packets,
means for measuring the time intervals separating the instants when the transmitted packets are received by the second point,
means for calculating the bandwidth.

### SHORT DESCRIPTION OF THE DRAWINGS

Other features and advantages of the invention will become apparent from the description which follows, taken as a non-limiting example, with reference to the appended figures wherein:

FIG. 1 schematically illustrates a digital line in a telecommunications network in which the method according to the invention is implemented,

FIG. 2 is a block diagram of a module for analyzing packets according to the invention.

### DETAILED DISCUSSION OF PARTICULAR EMBODIMENTS

The invention will now be described in an implementation on the Internet network.

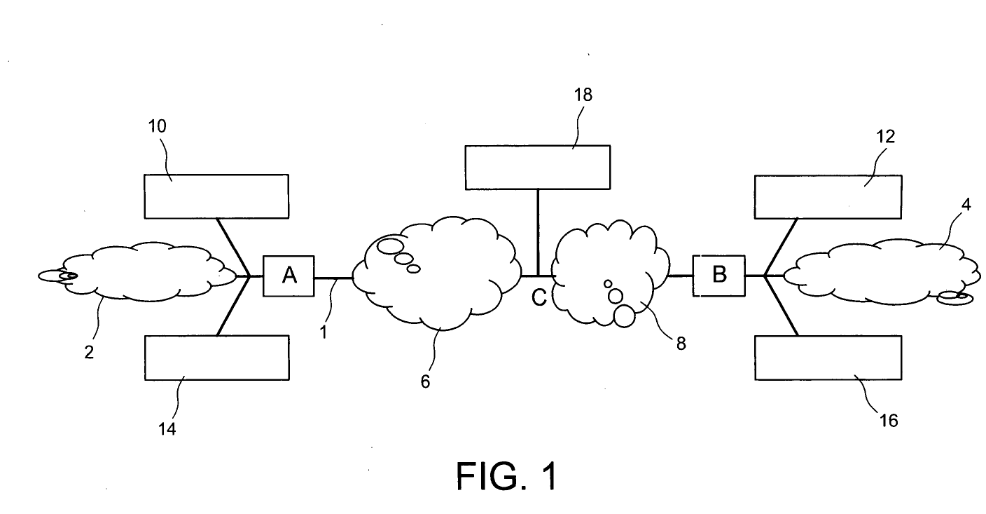

FIG. 1 schematically illustrates a bidirectional digital link 1 between a first terminal A and a second terminal B connected to a first local network 4 and to a second local network 6 respectively and exchanging digital data through a first sub-network 6 and a second sub-network 8 according to the TCP (Transmission Control Protocol) mode or according to the UDP (User Datagram Protocol). First and second modules (10, 12) for marking data packets transmitted by terminal A (B, respectively) and a module (14, 16) for analyzing data packets received by terminal A (B, respectively) are laid out at each end of the digital link 1 between terminals A and B, respectively.

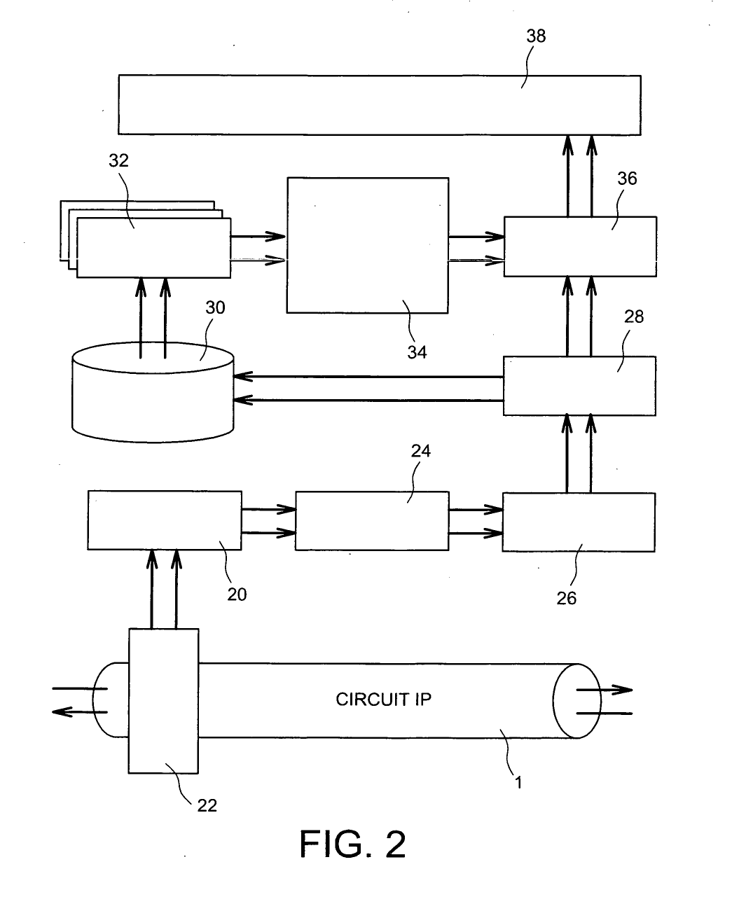

FIG. 2 schematically illustrates a block, diagram of an analysis module according to a preferred embodiment including an adaptation interface 20 connected to the IP link 1 via a coupler 22, a module 24 for extracting data packets from the link 1, a module 26 for acquiring said packets, a module 28 for time-stamping extracted packets for associating a same time identifier with a quasi-simultaneously transmitted group of packets, a memory 30 for storing the time-stamped packets, a module 32 for sorting packets with the same time identifier, a selection module 34 for isolating groups of packets with the same time identifier and the largest number of received packets, a module 36 for measuring the inter-packet transfer time and a module 38 for calculating the bandwidth.

In operation, each of the A or B terminals, may simultaneously be a transmitter and a receiver. The exchanged data transit through the networks 6 and 8, the respective congestions of which at a given time depend on the number of connected users. Marking of the packets is achieved following a request sent by the receiving terminal to the transmitting terminal. It may be achieved by enabling the time-stamping option described in the RFC 1323 standard for example.

To evaluate the available end-to-end bandwidth, the extraction module 24 isolates the data packets transmitted during a very short time from the transmitting terminal to the receiving terminal and transmits these packets to the time-stamping module 28 which associates a transmission date with each packet. The packets are then stored in the memory 30. The module 32 sorts the packets bearing the same sending date and transmits them to the module 34. The latter selects an integral number of groups from the sorted groups including the largest number of packets and transmits these groups to the measurement module 36 which measures the time intervals separating the reception of different successive packets. The measured intervals are then transmitted to the module 38 for calculating the bandwidth, which calculates on-line the bandwidth of the link according to the total length of the analyzed packets and to the transmission time of these packets.

To evaluate the available bandwidth in each sub-network, the analysis of the received packets is carried out by the third module 18 laid out between the sub-networks 6 and 8.

1. A method for evaluating the bandwidth between a first point and a second point liable to exchange digital data packets in a telecommunications network including a plurality of sub-networks, characterized in that it includes the following steps:
for each transmission direction through at least one of said sub-networks,
a. associating a same identifier with the quasi-simultaneously transmitted packets,
b. time-stamping and recording the received packets,
c. identifying and sorting the packets received with the same identifier,
d. selecting the largest possible integral number m of groups of packets with the same identifier,
e. measuring the time intervals separating the instants when the packets of the selected groups are received by the second point,
f. calculating the bandwidth according to the number of packets of the selected groups and to the total transmission time of these packets.

2. The method according to claim 1, characterized in that the bandwidth is calculated with the following expression:
$$\overline{BW} = \frac{1}{m} {\sum }_{j = 1}^{m} [ \frac{1}{{n}_{m}} {\sum }_{i = 1}^{{n}_{m}^{- 1}} \frac{{l}_{i , m}}{{t}_{( i + 1 ) m} - {t}_{i , m}} ]$$
wherein:
li,m represents the length of the packet of rank i of the m^{th} group of packets,
ti represents the time mark of the packet of rank i of the m^{th} group of packets,
ti+1 represents the time mark of the packet of rank i+1 of m^{th} group of packets,
n represents the number of packets of the m^{th} group of packets.

3. The method according to claim 2, characterized in that the number m is largest than or equal to 1.

4. The method according to claim 1, characterized in that marking of the data packets is achieved at the transmitting point upon a request from the receiving point.

5. The method according to claim 1, characterized in that the evaluation of the bandwidth is achieved on-line.

6. The method according to claim 1, characterized in that the evaluation of the bandwidth is achieved off-line.

7. The method according to claim 1, characterized in that the telecommunications network is of the IP type.

8. A device for evaluating the bandwidth between a first point and a second point liable to exchange digital data packets in a telecommunications network including a module for marking the transmitted packets and a module for analyzing the received packets, characterized in that the analysis module includes:
means for time-stamping the received packets,
means for sorting the received packets,
means for measuring the time intervals separating the instants when the transmitted packets are received by the second point,
means for calculating the bandwidth.

9. A module for analyzing data packets received in a telecommunications network, characterized in that it includes:
means for time-stamping the received packets,
means for sorting the received packets,
means for measuring the time intervals separating the instants when the transmitted packets are received by the second point,
means for calculating the bandwidth.
